(19) United States
(12) Patent Application Publication
(10) Pub. No.: US 2013/0124715 A1
(43) Pub. Date: May 16, 2013

(54) APPLET SYNCHRONIZATION ACROSS MULTIPLE ROUTERS

(71) Applicants: Aaron Hyman AVERBUCH, Seattle, WA (US); Rodney David Smith, Issaquah, WA (US); Thomas E. Logan, Bothell, WA (US); Aidan Nicholas Low, Seattle, WA (US); Daniel Richard Albertson, Issaquah, WA (US); Alan Scott Pearson, Seattle, WA (US)

(72) Inventors: Aaron Hyman AVERBUCH, Seattle, WA (US); Rodney David Smith, Issaquah, WA (US); Thomas E. Logan, Bothell, WA (US); Aidan Nicholas Low, Seattle, WA (US); Daniel Richard Albertson, Issaquah, WA (US); Alan Scott Pearson, Seattle, WA (US)

(21) Appl. No.: 13/294,921

(22) Filed: Nov. 11, 2011

(51) Int. Cl. G06F 11/00

(52) U.S. Cl. 709/224

(57) ABSTRACT

In one embodiment, a method is presented for determining which downloadable applets are exposed to a user of a computer when the computer is connected to a network. Included are the steps of detecting a change in the topology of a network, requesting from a router device topology information for the network, comparing the topology information against a requirements list associated with an application executing on the computing device, where the requirements list delineates at least one of a capability and a service necessary for the application to operate properly within a network, and determining whether the application is supported by the topology of the smart home network. If the application is supported, then the application is exposed, unless the application is not permitted to operate within the network. If the application is not supported or not permitted to operate within the network, then the application is not exposed.

### TECHNICAL FIELD

The present disclosure relates generally to home wireless networking.

### BACKGROUND

A home network enables Internet connectivity and data sharing among computing devices within a home that are connected to that network. To allow computing devices to be placed remotely from one another and/or from the network router, many home networks are fully or partially wirelessly connected. Wireless home networks typically include a wireless router that is hard wired to a modem. The modem, which is often provided by a telephone or cable company, is connected to an external network, such as the Internet, and allows information to flow between the external network and the home network. Each computing device in the home network is connected to the wireless router through a wireless network adapter that is either internal or external to the computing device.

When connecting to a home network, a computer on which pre-loaded applications reside is exposed to a new network topology over which new capabilities and services are offered. Those capabilities and services may or may not support the different pre-loaded applications on the computer. In situations where the new network topology does not support the operation of one or more pre-loaded applications, software executing on the computer that is responsible for connecting the computer to the home network may “gray out” icons representing those applications. While “graying out” the icons communicates to the user of the computer that those applications are not available on the new network, “grayed out” icons are relatively annoying and confusing to many users. Worse yet, in some instances, the software executing on the computer that is responsible for connecting the computer to the home network may not “gray out” any of the relevant icons and, instead, allow the user to attempt to launch the unsupported applications. As is well-appreciated, when an unsupported application is launched, a reasonably long period of time may transpire before a message indicating that the application cannot properly load/execute appears on the computer screen for the user to see. Such outcomes are even more annoying and frustrating for uses.

### BRIEF DESCRIPTION OF THE DRAWINGS

So that the manner in which the features of the present disclosure can be understood in detail, a more particular description of the disclosure may be had by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective embodiments.

FIG. 1A is an exemplary illustration of an overarching network system configured to implement one or more aspects of the present disclosure;

FIG. 1B illustrates the smart home network of FIG. 1A, according to one example embodiment of the present disclosure;

FIG. 1C illustrates the smart home network of FIG. 1A, according to another example embodiment of the present disclosure;

FIG. 1D illustrates the smart home network of FIG. 1A, according to yet another example embodiment of the present disclosure;

FIG. 1E is a more detailed illustration of the smart network host device of FIG. 1A, according to one example embodiment of the present disclosure;

FIG. 1F illustrates a system software architecture for the smart network host device of FIG. 1E, according to one example embodiment of the present disclosure;

FIG. 2 illustrates a more detailed view of the applet portal application of FIG. 1A, according to one example embodiment of the present disclosure; and

FIGS. 3A-3B set forth a flow diagram of method steps for determining which applets within a set of downloaded applets residing on a computer should be exposed to a user of the computer, according to one embodiment of the present disclosure.

### DETAILED DESCRIPTION OF EXAMPLE EMBODIMENTS

### Overview

One embodiment of the present disclosure sets forth a technique for determining whether to expose or to not expose an application for use with a computing device when there has been a change in the topology of the smart home network to which the computing device has just connected or has been connected. In one embodiment, a method includes detecting an event that changes a topology of a smart home network, requesting, from a router device included in the smart home network, topology information that describes the topology of the smart home network, and comparing the topology information against a requirements list associated with an application executing on a computing device that is connected to the smart home network, where the requirements list delineates at least one of a capability or a service necessary for the application to operate properly within a network. The method further includes determining, based on comparing, whether the application is supported by the topology of the smart home network, and, if the application is supported, then causing the application to be exposed for use with the computing device, unless the application is not permitted to operate within the smart home network, or, if the application is not supported or if the application is not permitted to operate within the smart home network, then causing the application to not be exposed for use with the computing device.

Other embodiments include, without limitation, a computer-readable medium that includes instructions that, when executed by a processing unit, cause the processing unit to carry out the above method as well as a computing device configured to implement the above method and a system that includes such a computing device.

### Example Embodiments

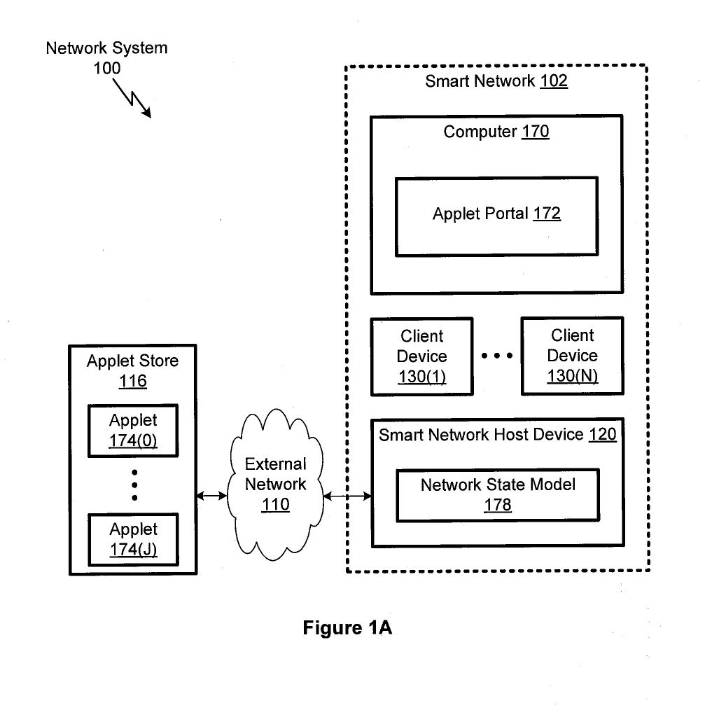

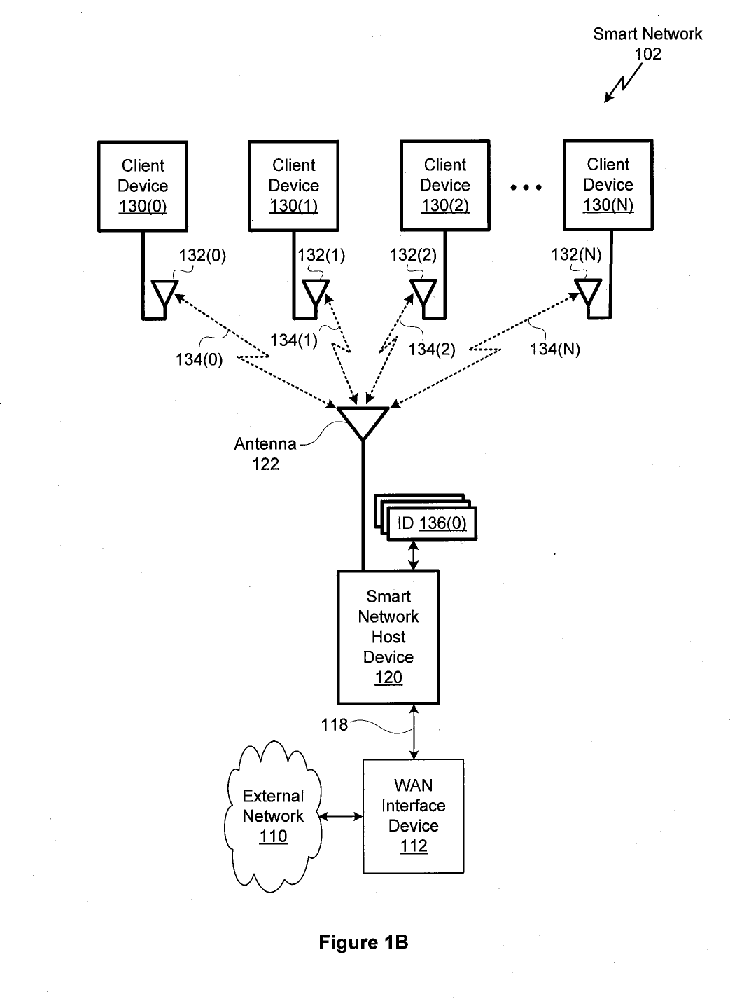

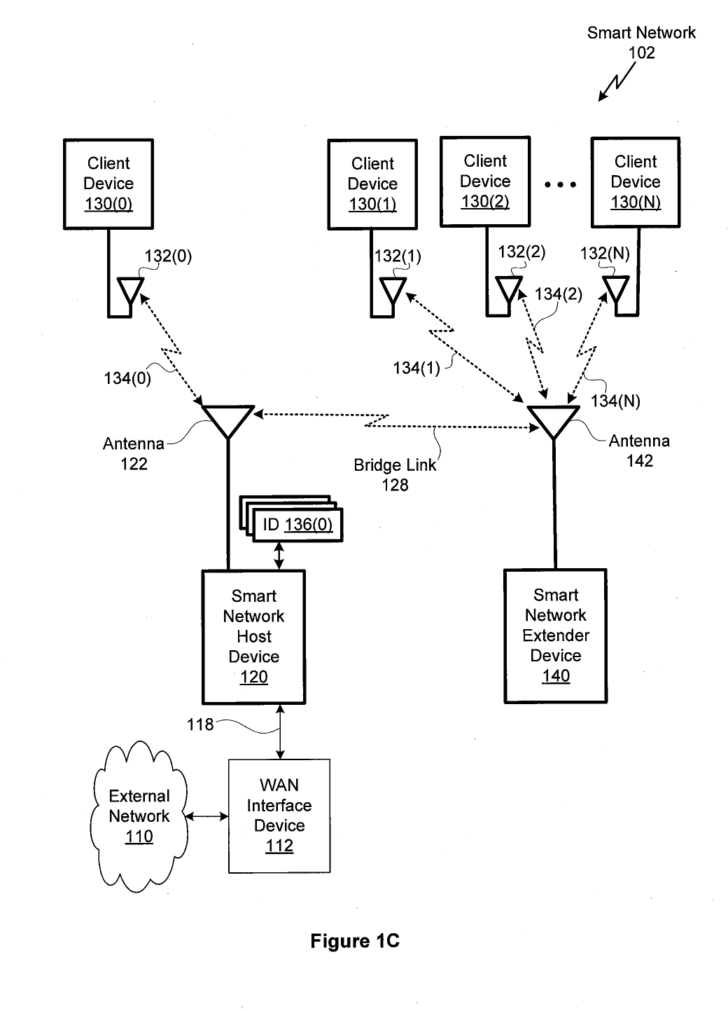

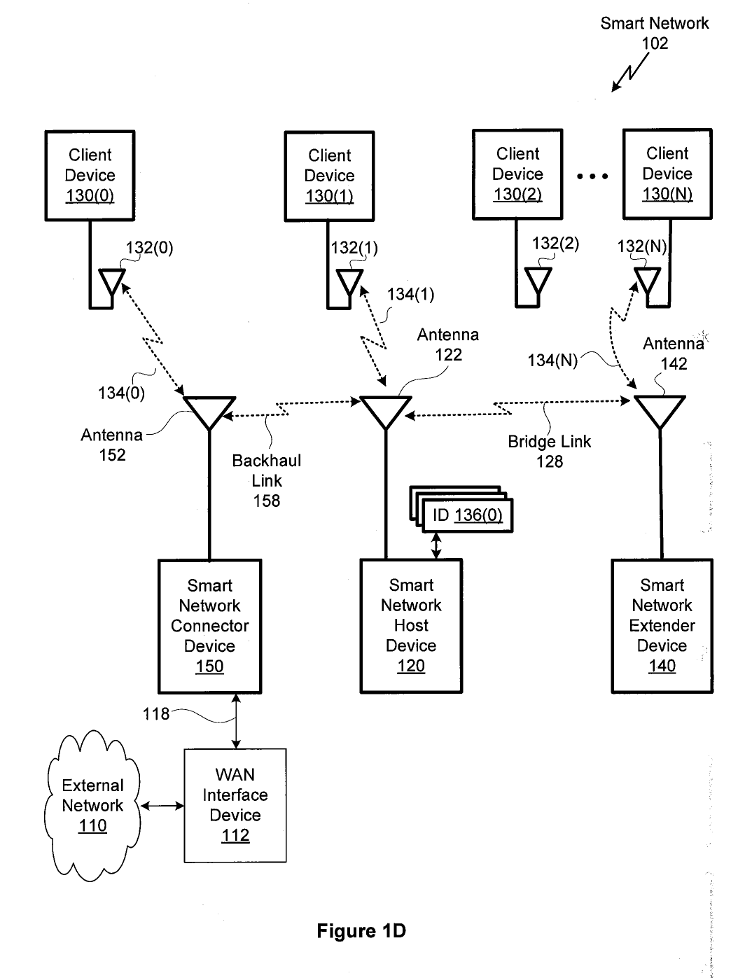

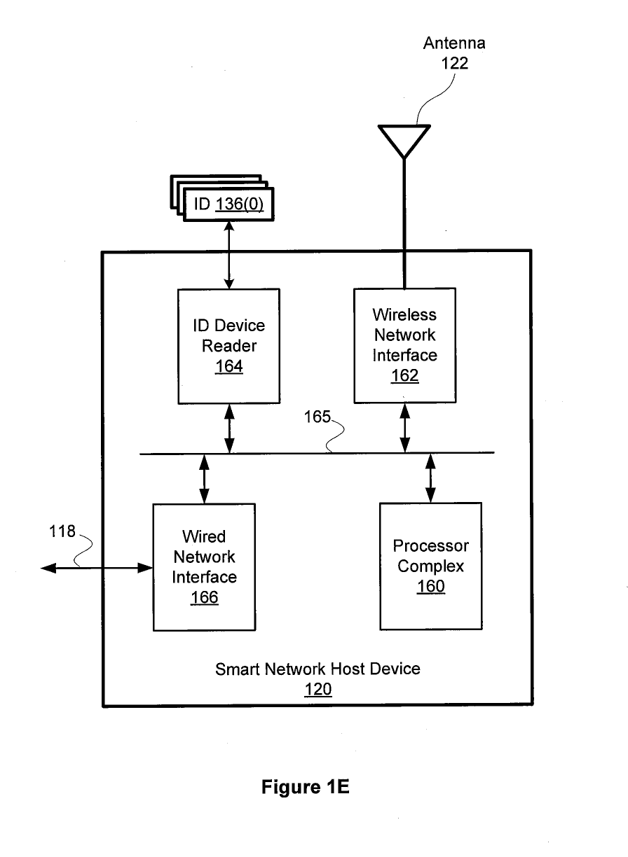

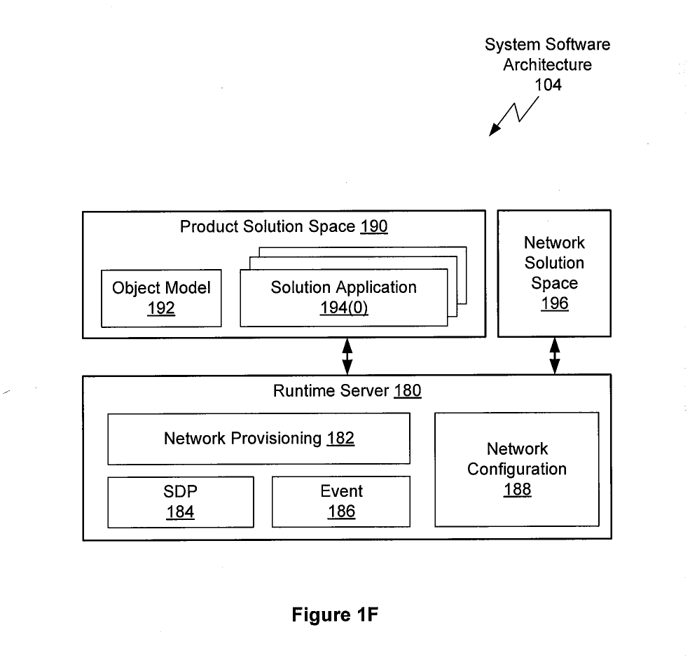

FIG. 1A illustrates a network system 100, configured to implement one or more aspects of the present disclosure. The network system 100 comprises a smart network 102, an external network 110, and an applet store 116. The external network 110 may comprise the well-known Internet or any other data network system. The smart network 102 includes a smart network host device 120 configured to transmit network data packets between the external network 110 and connected devices within the smart network 102, such as computer 170 and client devices 130. Any technically feasible wireless or wired physical transport technology may be implemented to transmit the network data packets. The smart network host device 120 maintains a network state model 178 that represents the different entities and related services operating within the smart network 102. For example, if client device 130(0) implements a printer with an integrated scanner and flash memory reader, then the network state model 178 would include an entry for client device 130(0), and related attributes for a printer service, scanner service, and file (or block device) service. New devices register with the smart network host device 120, which then updates the network state model 178 to include the new device.

An applet portal application 172, residing within the computer 170, is configured to access the network state model 178 to determine which client devices 130 are available within the smart network 102, which services the client devices 130 provide, and to access and use the services. The applet portal application 172 may download one or more applets 174, configured to extend functionality of the applet portal application 172, from the applet store 116. A given applet 174 may be associated with a specific client device 130 and may facilitate specific usage models for the client device 130 via the extended functionality. When a new client device 130 registers with the smart network 102, a most recent version of a corresponding applet 174 may not be available within the applet portal application 172. However, the applet portal application 172 may retrieve the corresponding applet 174 or version of the corresponding applet 174 from the applet store 116.

In alternative embodiments, the applet portal application 172 may be hosted externally to the smart network 102 in, for example, a cloud environment. In such embodiments, the computer 170 would access the applet portal application 172 through a network interface to realize the different functionalities of the applet portal application 172 described herein.

The applet store 116 is configured to facilitate access to applets 174 by the applet portal application 172. The applet store 116 provides storage for applets 174 corresponding to client devices 130 and makes the applets 174 available for download to the applet portal application 172 via the external network 110. In one embodiment, the applet store 116 occupies a well-known location, such as a universal resource locator (URL) associated with the external network 110. Any technically feasible technique may be used to identify a particular applet 174 as corresponding to a particular client device 130. Furthermore, any technically feasible technique may be used to download the particular applet 174 an incorporate the functionality of the applet 174 to the portal 172.

FIG. 1B illustrates the smart network 102, according to one embodiment of the present disclosure. As shown, the smart network 102 comprises a smart network host device 120, one or more client devices 130, and a wide area network (WAN) interface device 112, coupled to the external network 110 of FIG. 1A. The WAN interface device 112 may implement a cable modem, digital subscriber line (DSL) modem, fiber to the home interface, or any other technically feasible device that provides digital network connectivity to the external network 110. The WAN interface device 112 is coupled to the smart network host device 120 via a network interface 118. In one embodiment, the network interface 118 implements the well-known Ethernet standard.

The smart network host device 120 implements a wireless network interface coupled to antenna 122, which is configured to convert electrical signals to electromagnetic signals for transmitting data packets, and electromagnetic signals to electrical signals for receiving data packets. The antenna 122 may comprise plural independent radiator structures, each having a separate radiation pattern for implementing spatial multiplexing. In one embodiment, the wireless network interface implements one or more well-known standards, such as the Institute of Electrical and Electronics Engineers (IEEE) standard 802.11, which defines a system for wireless local area networking. The antenna 122 is configured establish wireless client links 134 to antennas 132 coupled to corresponding client devices 130. The smart network host device 120 implements Ethernet layer 2 switching for wireless data packets forwarded among client devices 130 as well as internet protocol (IP) layer 3 routing between an IP domain associated with the smart network 102 and the external network 110. In this configuration, the smart network host device 120 provides related services and protocols, such as dynamic host configuration protocol (DHCP), network address translation (NAT), and the like.

The smart network host device 120 acts as a central authentication authority for the smart network 102 and implements authentication services for devices registering with the smart network 102. In one embodiment, authentication is implemented via Identification (ID) devices 136 that are uniquely paired with corresponding client devices 130. For example, client device 130(0) may be uniquely paired with ID device 136(0) by a manufacturer of the client device 130(0). An ID device 136(0) is physically presented to the smart network host device 120 as an authentication credential to allow a client device 130(0) paired to the ID device 136(0) to join the smart network 102. Furthermore, the client device 130(0) is able to authenticate the smart network 102 as a trusted network by accessing credentials for the corresponding ID device 136(0) specifically via the smart network 102. In one embodiment, the ID devices 136 are implemented as near field radio frequency identification (RFID) tags. Each one of the RFID tags is configured to retain authentication credentials necessary to uniquely associate the one RFID tag with one instance of the client device 130. In this way, an RFID tag may be paired with a given client device 130. Persons skilled in the art will recognize that any technique may be implemented to generate and represent authentication credentials without departing the scope and spirit of the present disclosure. In alternative embodiments, other forms of ID devices 136 may implement storage of the authentication credentials. For example, a universal serial bus (USB) storage device may be used to present authentication credentials to the smart network host device 120 for authenticating a related device, such as the computer 170. In an alternative embodiments, a user may manually authenticate a client device 130 with the smart network host device 120. For example, the user may log onto a management web page generated by the smart network host device 120 and manually enter authentication credentials, such as a printed code associated with the client device 130. In yet another alternative embodiment, the device ID is communicated using a bar-code or QR code which is scanned by a camera attached to a host computer or built into the Smart Network Host Device 120.

In one usage scenario involving ID device 136, the user wishes to add a new device, such as a smart network-enabled printer to the smart network 102. The printer includes an ID device 136 implemented as an RFID tag that is paired to the printer. The user places the ID device 136 in close physical proximity to the smart network host device 120, which is the able to read the ID device 136 and authenticate the printer. The printer registers with the smart network host device 120 and is then available for use by devices connected within the smart network 102. Upon successfully reading the ID device 136, the smart network host device 120 may indicate success to the user by flashing a light-emitting diode (LED), or by generating any technically feasible indication.

FIG. 1C illustrates the smart network 102, according to another embodiment of the present disclosure. Here, the smart network 102 comprises a smart network host device 120, a smart network extender device 140, one or more client devices 130, and a wide area network (WAN) interface device 112, coupled to the external network 110 of FIG. 1A. The WAN interface device 112, smart network host device 120, and one or more client devices 130 are configured to operate as previously described in FIG. 1B.

In addition to previously described functionality, the smart network host device 120 is also configured to detect one or more smart network extender devices 140 and to establish a bridge link 128 to each of the one or more smart network extender devices 140. Each smart network extender device 140 is configured to act as a network bridge between a client device 130 and the smart network host device 120. For example, client devices 130(1) through 130(N) may be physically located such that they are able to connect to the smart network extender device 140, but not to the smart network host device 120. Furthermore, the smart network extender device 140 is able to connect to the smart network host device 120 via bridge link 128. Data packets transmitted by client devices 130(1) through 130(N) and destined to the external network 110 are received by the smart network extender device 140 and retransmitted by the smart network extender device 140 via bridge link 128 to the smart network host device 120, which then forwards the data packets to the external network 110. Similarly, data packets from the external network 110 that are destined to any of the client devices 130(1) through 130(N) are transmitted via bridge link 128 to the smart network extender device 140, which retransmits the data packets via wireless client links 134(1)-134(N). Persons skilled in the art will understand that wireless client links 134(1)-134(N) may each be configured to operate on a separate channel or band, or a common channel or band. Furthermore, bridge link 128 may operate on a separate channel or band with respect to the wireless client links 134.

In one embodiment, each smart network extender device 140 is paired to an ID device 136, which is presented as an authentication credential to the smart network host device 120 to enable the smart network extender device 140 to participate within the smart network 102.

FIG. 1D illustrates the smart network 102, according to yet another embodiment of the present disclosure. Here, the smart network 102 comprises a smart network host device 120, a smart network extender device 140, one or more client devices 130, a smart network connector device 150, and a wide area network (WAN) interface device 112, coupled to the external network 110 of FIG. 1A. The WAN interface device 112, smart network extender device 140, and one or more client devices 130 are configured to operate as previously described in FIGS. 1B and 1C.

In this embodiment, the smart network host device 120 is configured to operate similarly with respect to FIGS. 1B and 1C. However, upon detecting the smart network connector device 150, the smart network host device 120 is configured to operate as a bridge rather than a router, and the smart network connector device 150 is configured to operate as a router. A backhaul link 158 is established between the smart network host device 120 and the smart network connector device 150.

Network data traffic between client device 130(N) and the external network 110 traverses wireless client link 134(N), bridge link 128, and backhaul link 158. This network data traffic is also forwarded by smart network extender device 140, smart network host device 120, and smart network connector device 150. A client device 130 may connect directly to any one of the network extender device 140, smart network host device 120, or smart network connector device 150. As shown, client device 130(0) is connected to smart network connector device 150 via wireless client link 134(0), client device 130(1) is connected to smart network host device 120 via wireless client link 134(1), and client device 130(N) is connected to smart network extender device 140 via wireless client link 134(N).

In one embodiment, the smart network connector device 150 is paired to an ID device 136, which is presented as an authentication credential to the smart network host device 120 to enable the smart network connector device 150 to participate within the smart network 102. In an alternative embodiment, the smart network connector device 150 and the smart network host device 120 are paired during a manufacturing step, eliminating the need for a separate ID device 136.

FIG. 1E is a more detailed illustration of the smart network host device 120, according to one embodiment of the present disclosure. As shown, the smart network host device 120 comprises a processor complex, 160, a wireless network interface 162, an ID device reader 164, and a wired network interface 166. An interconnect 165 is configured to transmit data among the processor complex 160, wireless network interface 162, ID device reader 164, and wired network interface 166. The wired network interface 166 is configured to transmit data packets via network interface 118, based on data received via the interconnect 165. The wired network interface 166 is also configured to receive data packets from the network interface 118 and transmit contents of the received data packets to the processor complex 160 via the interconnect 165. The wireless network interface 162 is configured to transmit data packets, based on data received via the interconnect 165, to one or more network devices within range. The wireless network interface 162 is also configured to receive data packets from the one or more network devices and then transmit contents of the received packets to the processor complex 160. The wireless network interface 162 is coupled to an antenna 122.

The processor complex 160 comprises a central processing unit (CPU), non-volatile memory for storing persistent programs, program state, and configuration information, random access memory (RAM) for storing temporary or volatile data, and an interface to the interconnect 165. In one embodiment, the processor complex 160 is configured to execute an operating system and applications that provide routing services. The routing services may include, for example, data packet forwarding between the network interface 118 and the wireless network interface 162. The packet forwarding services may include, without limitation, bridging among the one or more network devices via the wireless network interface 162.

The ID device reader 164 is configured to read data from an associated ID device 136. In one embodiment, the ID device reader 164 is configured to read data from RFID tags comprising the ID device 136. The ID device reader 164 may also include a USB reader. In an alternative embodiment, ID device reader 164 is a camera and the ID is encoded into a bar-code or QR code which can be physically printed on the device or on the device's packaging.

In certain embodiments, the smart network host device 120 comprises one or more integrated circuits that implement respective functions of the smart network host device 120. For example, the processor complex 160, wired network interface 166, and wireless network interface 162 may be integrated into a single integrated circuit.

Persons skilled in the art will recognize that the smart network extender device 140 may be implemented using the basic architecture of the smart network host device 120, with the exception that the ID device reader 164 and wired network interface 166 are not required for the smart network extender device 140. Similarly, the smart network connector device 150 may be implemented using the basic architecture of the smart network host device 120, with the exception that the ID device reader 164 is not required for the smart network connector device 150.

FIG. 1F illustrates a system software architecture 104 for the smart network host device 120, according to one embodiment of the present disclosure. As shown, the software architecture 104 includes several software modules within the smart network host device 120. Programming instructions stored within the processor complex 160 implement a portion of the system software architecture 104 that includes a runtime server 180, a product solution space 190, and a network solution space 196. The product solution space 190 comprises an object model 192 and one or more solution applications 194. The object model 192 provides a standard, consistent abstraction of different network elements and related services within the smart network 102. Exemplary network elements include devices coupled to the smart network 102, such as printers, cameras, and display devices. Exemplary services include device and service discovery, event tracking and generation, and state presentation for the different elements. In one embodiment, the object model 192 includes a network interface based on the well-known extensible markup language (XML). One or more solution applications 194 provide specific functionality, such as a specific view of a storage system, or a specific technique for presenting certain data. The network solution space 196 includes software modules configured to provide management of network elements and network services, including device services, local area network services within the smart network 102, and wide area network services related to connectivity management of the external network 110.

The runtime server 180 comprises a network provisioning module 182, a service and discovery provisioning (SDP) module 184, an event module 186, and a network configuration module 188. The event module 186 tracks different network events, such as a network device advertising presence or updating status within the smart network 102. The SDP module 184 maintains a persistent view of different network devices and related services, based on data from the event module 186 and on data from the network devices. The network provisioning module 182 provides authentication and authorization for network devices within the smart network 102. Authentication credentials may be presented via a given ID device 136. The network provisioning module 182 may also facilitate certain network services, such as DHCP leases. The network configuration module 188 includes hardware platform-specific implementation methods for network configuration and management. The persistent view comprises the network state model 178 of FIG. 1A.

Persons skilled in the art will recognize that the smart network connector device 150 and smart network extender device 140 may be implemented using an appropriate subset of the system software architecture 104 described above in conjunction with FIG. 1F.

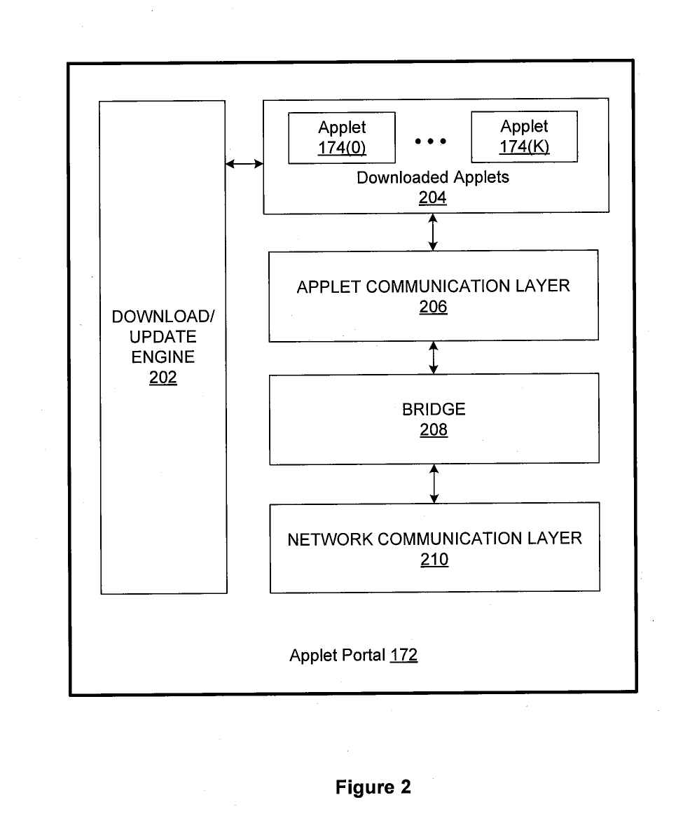

FIG. 2 illustrates a more detailed view of the applet portal application 172 of FIG. 1A, according to one example embodiment of the present disclosure. As shown, the applet portal application 172 includes a download/update engine 202, downloaded applets 204, an applet communication layer 206, a bridge 208 and a network communication layer 210.

As previously described herein, applets 174 published within the applet store 116 are downloaded to the computer 170 for execution. An applet 174 is a device applet or a service applet. A device applet is configured to display information about and/or provide logic to configure a particular client device 130. A service applet is configured to provide, to a user, additional functionality built on top of the smart network 102. Each applet 174 is packaged with a set of rules that must be satisfied within the smart network 102 for the applet 174 to function as desired.

In operation, the download/update engine 202 automatically downloads applets 174 from the application store 116 as the need arises. For example, when a new client device 130 is connected to the smart network 102, the download/update engine 202 receives an indication from the smart network host device 120 that the client device 130 has been connected. Other triggers include a client device 130 coming online, a routine applet download/update task or a new applet 174 becoming available within the applet store 116. In response, the download/update engine 202 downloads any applets 174 related to the newly connected client device 130. The downloaded applets 174 may include a device applet that configures the newly connected client device 130 within the smart network 102 and any service applets that utilize the newly connected client device 130.

To identify which applets 174 are to be downloaded, the download/update engine 202 accesses the network state model maintained by the smart network host device 120. Based on the network state model, the download/update engine 202 identifies applets 174 that are related to the client devices 130 within the smart network 102. In one case, there may be a 1-to-1 relationship between a particular client device 130 and a particular applet 174, for example a device applet associated with the client device. In other cases, if the smart network 102 includes a particular combination of client devices 130, then the download/update engine 202 may download an applet 174 that utilizes the combination of the client devices 130.

The download/update engine 202 keeps track of the different applets that have been downloaded, i.e., the downloaded applets 204. If an update is available in the applet store 116 of one of the downloaded applets 204, the download/update engine 202 automatically downloads the updated applet from the applet store 116. Another trigger to the automatic update of a downloaded applet 204 occurs when a client device 130 associated with the downloaded applet 204 is connected/re-connected to the client device 130, and the download/update engine 202 determines the status of each applet associated with the client device 130. In such a case, if a downloaded applet 204 requires an update, then the download/update engine 202 downloads the updates from the applet store 116.

A downloaded applet 204 executes within the applet portal application 172 to interact with the corresponding client devices 130. The downloaded applet 204 is, typically, a light-weight application from which the lower-level network model details and communications are abstracted by the applet portal application 172. In addition, interactions with system resources provided by the computer 170 that are needed to execute the downloaded applet 204 are also abstracted from the downloaded applet 204 by the applet portal application 172.

As previously described herein, the different client devices 130 within the smart network 102 have various capabilities and expose various services within the smart network 102. Each service is defined via a particular service definition that specifies a set of actions that can be performed on the associated device 130 based on the capabilities of the associated device 130. The services exposed by the client devices 130 enable the interaction between a particular client device 130 and a downloaded applet 174.

In one embodiment, a particular applet 174 specifies a set of operating requirements that should be satisfied by the smart network 102 for the applet 174 to operate properly within the smart network 102. Such requirements may include the capabilities and services that need to be provided by the different client devices 130 included in the smart network 102 to properly support the operation of the applet 174. The download/update engine 202 is configured to maintain a list of these operating requirements for each of the applets 174 included in the set of downloaded applets 204 residing on the computer 170. Again, each such list sets forth the capabilities and services that should be provided by the other devices on the smart network 102 for the associated applet 174 to operate properly within the smart network 102.

When the computer 170 first joins the smart network 102, the download/update engine is configured to request from the device within the smart network 102 having router functionality (e.g., smart network host device 120 or smart network connector device 150) topology information that describes the topology of the smart network 102. In particular, the topology information delineates all of the capabilities and services provided to the smart network 102 by the various devices connected to the smart network 102, including the different client devices 130. Upon receiving the topology information from the router device, the download/update engine 202 is configured to compare the topology information to the different lists of operating requirements for the applets 174 included in the set of downloaded applets 204. For a particular applet 174, if the operating requirements set forth in the list of operating requirements associated with the applet 174 is included in the topology information, then the download/update engine 202 concludes that the topology of the smart network 102 supports the operation of the applet 174 within the smart network 102. In such a case, the download/update engine 202 is configured to cause the applet 174 to be exposed to the user of the computer 170. In one embodiment, the download/update engine 202 turns on the applet 174 to expose the applet 174 to the user. If the operating requirements set forth in the list of operating requirements is not included in the topology information, then the download/update engine 202 concludes that the topology of the smart network 102 does not support the operation of the applet 174 within the smart network 102. In such a case, the download/update engine 202 causes the applet 174 to not be exposed to the user of the computer 170. Because the applets 174 included in the set of downloaded applets 204 are typically turned off when the computer 170 first joins the smart network 102, in one embodiment, not exposing the applet 174 entails not turning on the applet 174.

In this fashion, download/update engine 202 exposes to the user of the computer 170 only the applets 174 that are able to operate properly within the smart network 102. Consequently, the user advantageously does not see any “grayed out” applets on the display of computer 170, and each applet shown to the user on the display is guaranteed to launch and operate properly for the user.

In other embodiments, certain applets 174 may be configured to operate only within a particular network that may or may not be the smart network 102. In such embodiments, the applet 174 is associated with a specific router device identifier, like a media access control (MAC) address or other unique identifier. The upload/update engine 202 is configured to keep track of which applets 174 in the set of downloaded applets 204 are associated with these types of router device identifiers. The upload/update engine is further configured to request from the device in the smart network 102 having router functionality the MAC address or other unique identifier associated with that device. Upon receiving the MAC address or other unique identifier, for each applet 174 in the set of downloaded applets 204, the download/update engine is configured to compare that MAC address or other unique identifier with the specific router device identifier, if any, associated with the applet 174. If the specific router identifier associated with the applet 174 does not match the MAC address or other unique identifier received from the device within the smart network 102 having router functionality, then the download/update engine 202 concludes that the applet 174 is not permitted to operate within the smart network 102 and does not expose the applet 174 to the user of the computer 170. If the specific router identifier associated with the applet 174 matches the MAC address or other unique identifier received from the device with the smart network 102 having router functionality, then the download/update engine 202 concludes that the applet 174 is permitted to operate within the smart network 102. One should note that, in cases where an applet 174 is not associated with any specific router device identifier, the download/update engine 202 is configured to conclude that applet 174 is permitted to operate within the smart network 102. In cases where the download/update engine 202 concludes that the applet 174 is permitted to operate within the smart network 102, the download/update engine 202 is configured to cause the applet 174 to be exposed to the user of the computer 170 only if the topology of the smart network 102 properly supports the operation of the applet 174, as described above.

In yet other embodiments, after the computer 170 is connected to the smart network 102, and an initial set of applets 174 in the set of downloaded applets 204 has been exposed to the user of the computer 170, the download/update engine 202 is configured to monitor the smart network 102 for any changes in the topology of the smart network 102. A change in the topology of the smart network 102 may be caused by one or more devices joining the smart network 102, including the computer 170 initially joining the smart network 102, or by one or more devices disconnecting from the smart network 102. In such cases, the download/update engine 202 is configured to request again from the device in the smart network 102 having routing functionality the topology information that describes the topology of the smart network 102. The download/update engine 202 is configured to reevaluate which applets 174 in the set of downloaded applets 204 are supported by the new topology of the smart network 102. In so doing, the download/update engine 202 follows the same process described above in determining whether the topology of the smart network 102 supports the operation of a particular applet 174 within the smart network 102 and then either causing the that applet 174 to be exposed or to not be exposed to the user of the computer 170. However, in cases where the download/update engine 202 concludes that the applet 174 should not be exposed to the user, and the applet 174 had been turned on previously and exposed to the user, the download/update engine is configured to turn off the applet 174.

In operation, the applet portal application 172 hosts a web browser control (not shown) that operates as an execution container for a particular downloaded applet 204 that is currently loaded. Alternatively, the computer 170 may include a web browser (not shown) within which any downloaded applet 204 may be executed. To load the downloaded applet 204, the applet portal application 172 injects the applet communication layer 206 and the bridge 208 into the context of the web browser control. The applet communication layer 206 exposes a set of high-level application program interfaces (APIs) that allow the downloaded applet 204 to communicate with the system resources of the computer 170 as well as the smart network host device 120 and the corresponding client devices 130 in an intuitive manner. The applet communication layer 206 wraps the bridge 208, such that APIs exposed by the applet communication layer 206 internally call into the methods exposed by the bridge 208.

The bridge 208 provides an interface between the applet communication layer 206 and the network communication layer 210. The bridge 208 exposes methods to the applet communication layer 206 that allow the downloaded applet 204 to invoke pre-defined actions on the corresponding client devices 130, subscribe to and unsubscribe from events that can be raised within the smart network 102, etc. These methods, when executed, call on underlying functions provided by the network communication layer 210 to interact with the smart network 102. In addition, the bridge 208 exposes methods that, when executed, allow the applet 204 to interact with an operating system (not sown) executing within the computer 170 to access system-level resources, such as a file system, network input/output, etc.

The network communication layer 210 is configured with logic that enables the communication between the client devices 130 specified by the bridge 208 via the smart network host. The network communication layer 210 also enables the downloaded applet 204 to interact with the smart network host device 120. For example, the network communication layer 210 can embody a security model related to the smart network host device 120 to allow or disallow commands and requests that can be transmitted to devices within the smart network 102. In one embodiment, the network communication layer 210 is separate from the applet portal 172 to provide services to external callers regardless of whether the applet portal 172 is executing. In such an embodiment, requests to the applet portal 172 can be queued via the separately executing network communication layer 210 when the applet portal 172 is not executing.

In one embodiment, the downloaded applet 204 and the applet communication layer 206 are implemented in Javascript, the network communication layer 210 is implemented in C++, and the bridge 208 provides an interface between the Javascript layer and the C++ layer.

In such a manner, the downloaded applet 204, via the tri-layered execution environment, i.e., the applet communication layer 206, the bridge 208, and the network communication layer 210, can interact with the different client devices 130 within the smart network 102. For example, the downloaded applet 204 can retrieve information about the client devices 130 within the smart network 102, perform actions on the client devices 130 and subscribe to any relevant alerts/events within the smart network 102. Based on the interactions, the downloaded applet 204 can either configure the corresponding client devices 130 to operate as desired, or provide additional functionality to a user that is built on top of the various services exposed by the corresponding client devices 130.

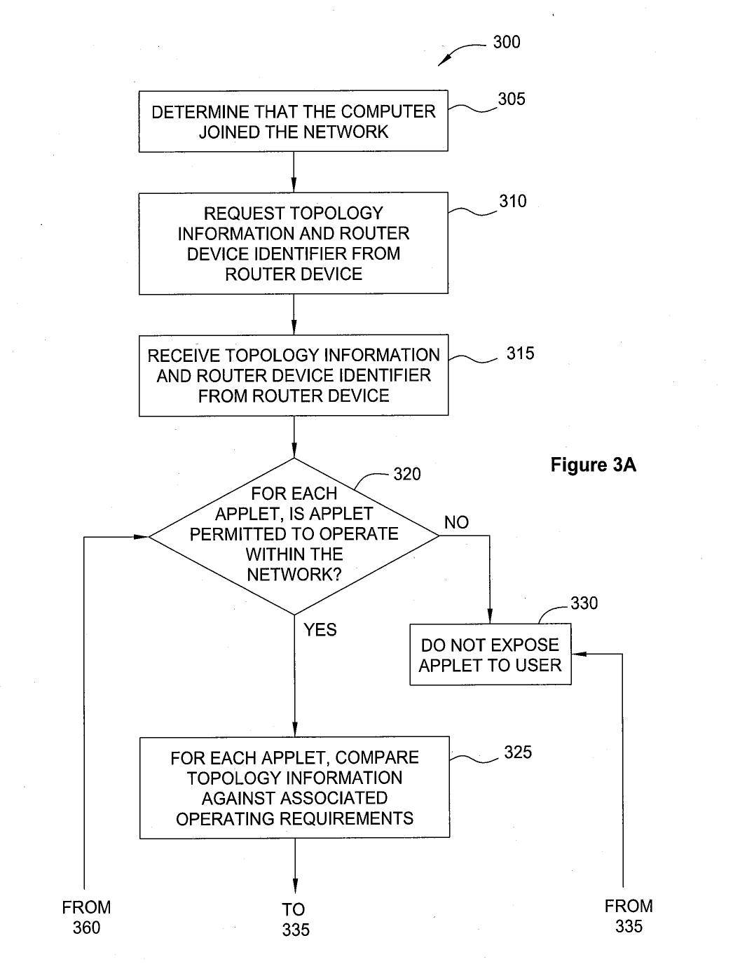

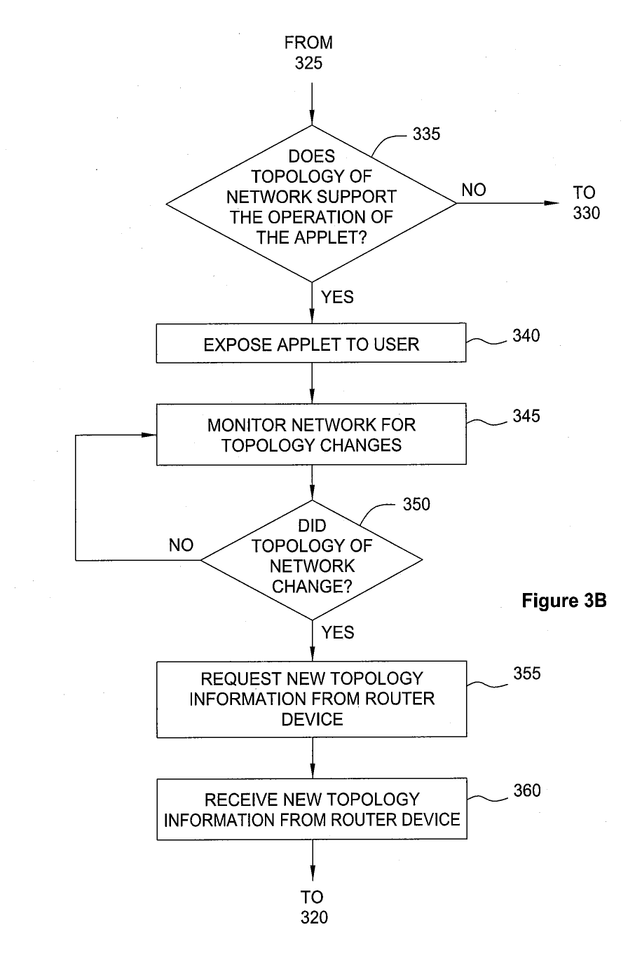

FIGS. 3A-3B set forth a flow diagram of method steps for determining which applets 174 within the set of downloaded applets 204 residing on computer 170 should be exposed to a user of computer 170, according to one embodiment of the present disclosure. Persons skilled in the art will understand that, although the method 300 is discussed with respect to the system of FIGS. 1A-2, any system that implements the method steps, in any order, falls within the scope of the present disclosure.

The method 300 begins in step 305, where the download/update engine 202 residing within computer 170 determines that compute 170 had joined the smart network 102. In step 310, the download/update engine 202 requests topology information associated with the smart network 102 from the device within the smart network 102 having router functionality (e.g., smart network host device 120 or smart network connector device 150). As previously discussed herein, the topology information delineates all of the capabilities and services provided to the smart network 102 by the various devices connected to the smart network 102, including the different client devices 130. The download/update engine 202 also requests a router device identifier from that device as well. In step 315, the download/update engine 202 receives the topology information and the router device identifier from the device on the smart network 102 from which that information was requested.

In step 320, for each applet 174 in the set of downloaded applets 204, the download/update engine 202 determines whether the applet 174 is permitted to operate within the smart network 102. In some instances, a particular applet 174 may be configured to operate only in a specifically designated network. That network may be identified by a particular router device identifier, such as the MAC address of a particular router device or some other unique identifier of that router device. Therefore, in one embodiment, for each applet 174 associated with a particular router device identifier, the download/update engine 202 compares that router device identifier to the router device identifier associated with the smart network 102 and received by the download/update engine 202 in step 315. If the router device identifier associated with the applet 174 matches the router device identifier associated with the smart network 102, then the download/update engine 202 concludes that the applet 174 is permitted to operate within the smart network 102. If the two router device identifiers do not match, then the download/update engine 202 concludes that the applet 174 is not permitted to operate within the smart network 102. In one embodiment, if an applet 174 happens to not be associated with any router device identifier, then, as a default, the download/update engine 202 concludes that the applet 174 is permitted to operate within the smart network 102.

If, in step 320, an applet 174 is not permitted to operate within the smart network 102, then, in step 330, the download/update engine 202 causes the applet 174 to not be exposed to the user of computer 170. In one embodiment, not exposing the applet 174 means that the applet 174 is not turned on. For the applets 174 in step 320 that are permitted to operate within the smart network 102, the method proceeds to step 325.

In step 325, for each applet 174 permitted to operate within the smart network 102, the download/update engine 202 compares the topology information associated with the smart network 102 with the operating requirements associated with the applet 174. In step 335, for each applet 174 permitted to operate within the smart network 102, the download/update engine 202 determines whether the topology of the smart network 102 supports the operation of that applet 174. If the operating requirements associated with the applet 174 are included in the topology information associated with the smart network 102, then the download/update engine 202 concludes that the operation of the applet 174 is supported, and the method proceeds to step 340, where the download/update engine 202 causes the applet 174 to be exposed to the user of computer 170. In one embodiment, to expose an applet 174 to the user of computer 170, the download/update engine 202 turns on the applet 174. If, however, the operating requirements associated with the applet 174 are not included in the topology information associated with the smart network 102, then the download/update engine 202 concludes that the operation of the applet 174 is not supported by the topology of the smart network 102, and the method returns to step 330.

In step 345, the download/update engine 202 monitors the smart network for topology changes. As persons skilled in the art will recognize, a topology change occurs whenever a device is added to or removed from the smart network 102. If, in step 350, download/update engine determines that no change in the topology has occurred, then download/update engine 202 returns to step 345 and continues to monitor the smart network 102 for topology changes. If, in step 350, download/update engine determines that a change in the topology of the smart network 102 has occurred, then the method proceeds to step 355, where the download/update engine 202 requests topology information associated with the new topology of the smart network 102 from the device within the smart network 102 having router functionality. In step 360, the download/update engine 202 receives the new topology information from the device within the smart network 102 having routing functionality. The method then returns to step 320, wherein the download/update engine 202 determines which of the applets 174 in the set of downloaded applets 204 residing on computer 170 are permitted to operate within the smart network 102, as previously described herein.

Persons skilled in the art will recognize that, in returning to step 320, any applet 174 in the set of downloaded applets 204 that has already been turned on by the download/update engine 202 is retested for operational compatibility with the new topology of the smart network 102. If, upon returning to step 335, the download/update engine 202 determines that the new topology of the smart network 102 does not support the operation of any such applet 174, then, upon returning to step 330, the download/update engine 202 turns off that applet 174 so that the applet 174 is no longer exposed to the user of computer 170. Further, in returning to step 320, any new applet 174 downloaded to computer 170 while computer 170 is connected to the smart network 102 is analyzed first to determine whether that applet is permitted to operate within the smart network 102 and, if so, then to determine whether the topology of the smart network 102 supports the operation of that applet 174 within the smart network 102, as previously described herein.

Various embodiments may be implemented as program products for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Another embodiment may be implemented as a program product deployed for use over a network. In such an embodiment, the program product may be accessed via a web browser.

The disclosure has been described above with reference to specific embodiments. Persons skilled in the art, however, will understand that various modifications and changes may be made thereto without departing from the broader spirit and scope of the disclosure as set forth in the appended claims. The foregoing description and drawings are, accordingly, to be regarded in an illustrative rather than a restrictive sense.

We claim:

1. A method, comprising:
detecting an event that changes a topology of a smart home network;
requesting, from a router device included in the smart home network, topology information that describes the topology of the smart home network;
comparing the topology information against a requirements list associated with an application executing on a computing device that is connected to the smart home network, wherein the requirements list delineates at least one of a capability or a service necessary for the application to operate properly within a network;
determining, based on comparing, whether the application is supported by the topology of the smart home network; and
if the application is supported, then causing the application to be exposed for use with the computing device, unless the application is not permitted to operate within the smart home network, or
if the application is not supported or if the application is not permitted to operate within the smart home network, then causing the application to not be exposed for use with the computing device.

2. The method of claim 1, wherein detecting an event that changes the topology of the smart home network comprises detecting that the computing device has joined the smart home network.

3. The method of claim 1, wherein detecting an event that changes the topology of the smart home network comprises detecting that another device has either joined or disconnected from the smart home network.

4. The method of claim 3, further comprising monitoring the smart home network for a change in the topology of the smart home network.

5. The method of claim 1, the topology information comprises the capabilities of and the services provided by all devices connected to the smart home network.

6. The method of claim 5, wherein the application is supported by the topology of the smart home network if the capabilities and services needed by the application to operate properly within a network are included in the topology information, and the application is not supported by the topology of the smart home network if the capabilities and services needed by the application to operate properly within a network are not included in the topology information.

7. The method of claim 1, wherein causing the application to be exposed to the user comprises turning on the application, and causing the application to not be exposed to the user comprises either not turning on the application or turning off the application if the application is already turned on.

8. The method of claim 1, further comprising requesting from the router device an identifier that uniquely identifies the router device.

9. The method of claim 1, further comprising comparing the identifier that uniquely identifies the router device with a first identifier associated with the application to determine whether the application is permitted to operate within the smart home network.

10. The method of claim 9, wherein the application is not permitted to operate within the smart home network if the first identifier does not match the identifier that uniquely identifies the router device.

11. A non-transitory computer-readable medium including instructions that, when executed by a processing unit, cause the processing unit to perform the steps of:
detecting an event that changes a topology of a smart home network;
requesting, from a router device included in the smart home network topology, information that describes the topology of the smart home network;
comparing the topology information against a requirements list associated with an application executing on a computing device that is connected to the smart home network, wherein the requirements list delineates at least one of a capability or a service necessary for the application to operate properly within a network;
determining, based on comparing, whether the application is supported by the topology of the smart home network; and
if the application is supported, then causing the application to be exposed for use with the computing device, unless the application is not permitted to operate within the smart home network, or
if the application is not supported or if the application is not permitted to operate within the smart home network, then causing the application to not be exposed for use with the computing device.

12. The non-transitory computer-readable medium of claim 11, wherein detecting an event that changes the topology of the smart home network comprises detecting that the computing device has joined the smart home network.

13. The non-transitory computer-readable medium of claim 11, wherein detecting an event that changes the topology of the smart home network comprises detecting that another device has either joined or disconnected from the smart home network.

14. The non-transitory computer-readable medium of claim 13, further comprising monitoring the smart home network for a change in the topology of the smart home network.

15. The non-transitory computer-readable medium of claim 11, the topology information comprises the capabilities of and the services provided by all devices connected to the smart home network.

16. The non-transitory computer-readable medium of claim 15, wherein the application is supported by the topology of the smart home network if the capabilities and services needed by the application to operate properly within a network are included in the topology information, and the application is not supported by the topology of the smart home network if the capabilities and services needed by the application to operate properly within a network are not included in the topology information.

17. The non-transitory computer-readable medium of claim 11, wherein causing the application to be exposed to the user comprises turning on the application, and causing the application to not be exposed to the user comprises either not turning on the application or turning off the application if the application is already turned on.

18. The non-transitory computer-readable medium of claim 11, further comprising requesting from the router device an identifier that uniquely identifies the router device.

19. The non-transitory computer-readable medium of claim 11, further comprising comparing the identifier that uniquely identifies the router device with a first identifier associated with the application to determine whether the application is permitted to operate within the smart home network.

20. The non-transitory computer-readable medium of claim 19, wherein the application is not permitted to operate within the smart home network if the first identifier does not match the identifier that uniquely identifies the router device.

21. A system, comprising:
a computing device that includes a portal application configured to:
detect an event that changes a topology of a smart home network;
request, from a router device included in the smart home network topology, information that describes the topology of the smart home network;
compare the topology information against a requirements list associated with an application executing on a computing device that is connected to the smart home network, wherein the requirements list delineates at least one of a capability or a service necessary for the application to operate properly within a network;
determine, based on comparing, whether the application is supported by the topology of the smart home network; and
if the application is supported, then expose the application for use with the computing device, unless the application is not permitted to operate within the smart home network, or
if the application is not supported or if the application is not permitted to operate within the smart home network, then not expose the application for use with the computing device.
